(19) United States
(12) Patent Application Publication
(10) Pub. No.: US 2019/0031922 A1
(43) Pub. Date: Jan. 31, 2019

(54) OPTICAL SILICONE DOUBLE-SIDE TAPE COMPRISING A SILICONE SUBSTRATE LAYER HAVING LOW STORAGE MODULUS

(71) Applicant: Dow Silicones Corporation, Midland, MI (US)

(72) Inventors: Ho Jin CHOI, Chungcheongbuk-do (KR); Mincheol JEON, Chungcheongbuk-do (KR); Sun Hee KIM, Chungcheongbuk-do (KR)

(21) Appl. No.: 16/085,844

(22) PCT Filed: Mar. 24, 2017
(86) PCT No.: PCT/US2017/023983

§ 371 Date: Sep. 17, 2018

(30) Foreign Application Priority Data
Mar. 24, 2016 (KR) 10-2016-0035572

(51) Int. Cl. C09J 7/25; C09J 7/40; C09J 133/00

(52) U.S. Cl. CPC C09J 7/25; C09J 7/405; C09J 2467/005; C09J 2483/006; C09J 133/00

(57) ABSTRACT

An optical silicone double-side tape is disclosed. The optical silicone double-side tape comprises a silicone substrate layer having low storage modulus. Specifically, the optical silicone double-side tape comprises a multi-layered adhesive layer and release liners formed on both sides of the multi-layered adhesive layer. The multi-layered adhesive layer comprises the silicone substrate layer and a pressure-sensitive adhesive layer formed on at least one side of the silicone substrate layer. The pressure-sensitive adhesive layer has higher G′ modulus than the silicone substrate layer.

The present invention relates to an optical silicone double-side tape comprising a silicone substrate layer having low storage modulus. Specifically, it is related to an optical silicone double-side tape comprising: a multi-layered adhesive layer comprising; a silicone substrate layer, and a pressure-sensitive adhesive layer formed on one or both sides of the silicone substrate layer; and release liners formed on both sides of the multi-layered adhesive layer.

### BACKGROUND ART

An optical adhesive tape can be used in a wide range of temperature when it is tacky at both low and high temperatures to be applied for flexible, bendable, and foldable products.

FIG. 1 is a sectional view of a conventional optical acrylic adhesive tape 1. As illustrated in FIG. 1, the conventional optical acrylic adhesive tape 1 consists of an optical acrylic adhesive layer 10 having a specific thickness, and first and second release liners 12, 14. The conventional optical acrylic adhesive tape 1 has high modulus and shows high adhesive strength and stable coherence in fixed form of products. However, it cannot show appropriate characteristics in products of which shapes are changed, such as flexible, bendable, and foldable products.

In other words, the modulus of polymer materials rapidly changes at low temperatures, and in case of having a high modulus, the adhesive performances are lost and only a rigid property as a solid remains at low temperatures. In order to have an adhesive performance, i.e. viscoelasticity, an appropriate level of modulus is required at a certain temperature when used. Hence, the conventional optical organic adhesives including optical acrylic adhesive tapes are disadvantageous as they cannot be used in a wide range of temperature.

On the other hand, silicone adhesives provide a stable modulus in a wider range of temperature compared to the conventional optical organic adhesives. However, there is a weakness in high temperatures in that the adhesive strength drastically drops and the function as an adhesive deteriorates.

Korean patent no. 10-1191906 (published on Oct. 16, 2012) discloses an optical adhesive wherein a silicone adhesive layer is formed. However, the object of the reference is to control the release forces to be different by modifying the tackiness of the two sides of a silicone adhesive substrate layer, not increase the adhesive strength of the tape.

### Problems to be Solved

The present invention solves the aforementioned problems. The first objective of the present invention is to provide an optical double-side tape which can be used in devices that are used in a wide range of temperature by providing a double-side tape wherein a silicone substrate layer is used so that a stable modulus is shown in a wide range of temperature to maintain adherence.

In addition, the second objective of the present invention is to provide an optical tape in which the total modulus of a tape is set by using a silicone substrate layer having low modulus and an adhesive layer having high modulus formed on one or both sides of the silicone substrate layer, or in which adhesive strengths of both sides are provided differently.

### Solution to Problems

The above objective(s) can be achieved by an optical silicone double-side tape comprising: a multi-layered adhesive layer comprising; a silicone substrate layer, and a pressure-sensitive adhesive layer formed on one or both sides of the silicone substrate layer; and release liners formed on both sides of the multi-layered adhesive layer; wherein the pressure-sensitive adhesive layer has a higher G′ modulus than the silicone substrate layer.

### Effects of the Invention

By using a tape wherein an adhesive layer having a relatively high modulus is stacked to a silicone substrate layer having low modulus in a wide range of temperature, an optical double-side tape is provided of which the modulus is maintained low at low temperatures while high adhesive strength is provided at high temperatures.

In addition, by designing the adhesive strengths of the two sides of a tape to be different, or by adding color, fragrance, etc., various demands of customers are fulfilled, and the value of the products are increased.

### BRIEF DESCRIPTION OF THE DRAWINGS

FIG. 1 is a sectional view of a conventional optical acrylic adhesive tape 1.

FIG. 2 is a sectional view of a bi-layered optical silicone double-side tape 2 according to one embodiment of the present invention.

FIG. 3 is a sectional view of a three-layered optical silicone double-side tape 3 according to one embodiment of the present invention.

FIG. 4 is a sectional view of a multi-layered optical silicone double-side tape 4 according to one embodiment of the present invention.

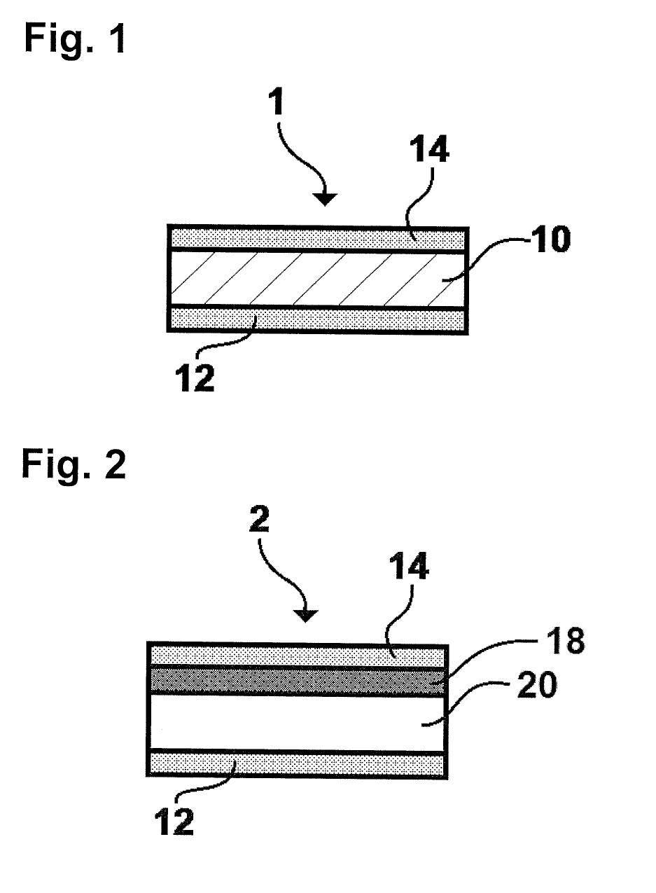

### EMBODIMENTS OF THE INVENTION

Hereinafter, the present invention will be described in detail. However, the following description is intended to explain the invention, and is not meant in any way to restrict the scope of the invention.

The present invention relates to an optical silicone double-side tape comprising a silicone substrate layer having low storage modulus. Specifically, it is related to an optical silicone double-side tape comprising: a multi-layered adhesive layer comprising; a silicone substrate layer, and a pressure-sensitive adhesive layer formed on at least one side (or both sides) of the silicone substrate layer; and release liners formed on both sides of the multi-layered adhesive layer; wherein the pressure-sensitive adhesive layer has a higher G′ modulus than the silicone substrate layer. As used herein, the terms “formed” and “forming” can also be “disposed” and “disposing.” In addition, the term “multi-layered” can mean two or more layers, e.g. two layers, three layers, four layers, five layers, etc.

The modulus values used in the present invention are all storage modulus (G′ modulus). In the present invention, the G′ modulus is measured using AR-G2 rheometer of TA Instruments under the following conditions. Similar data will be obtained even if other similar equipment is used.
disc having a diameter of 8 mm
ramp rate of 5° C./min from −60 to 120° C. frequency of 6.28 rad/sec (1 Hz)
strain 0.05%
thickness of the specimen of 0.5 to 1.0 mm

FIG. 2 is a sectional view of a bi-layered optical silicone double-side tape 2 according to one embodiment of the present invention. As illustrated in FIG. 2, a multi-layered adhesive layer of a bilayer is formed by forming a pressure-sensitive adhesive layer 18 on a silicone substrate layer 20. The pressure-sensitive adhesive layer 18 can be formed under the silicone substrate layer 20 (not shown). The optical silicone double-side tape of the present invention is provided by forming release liners 12, 14 on both sides of the multi-layered adhesive layer.

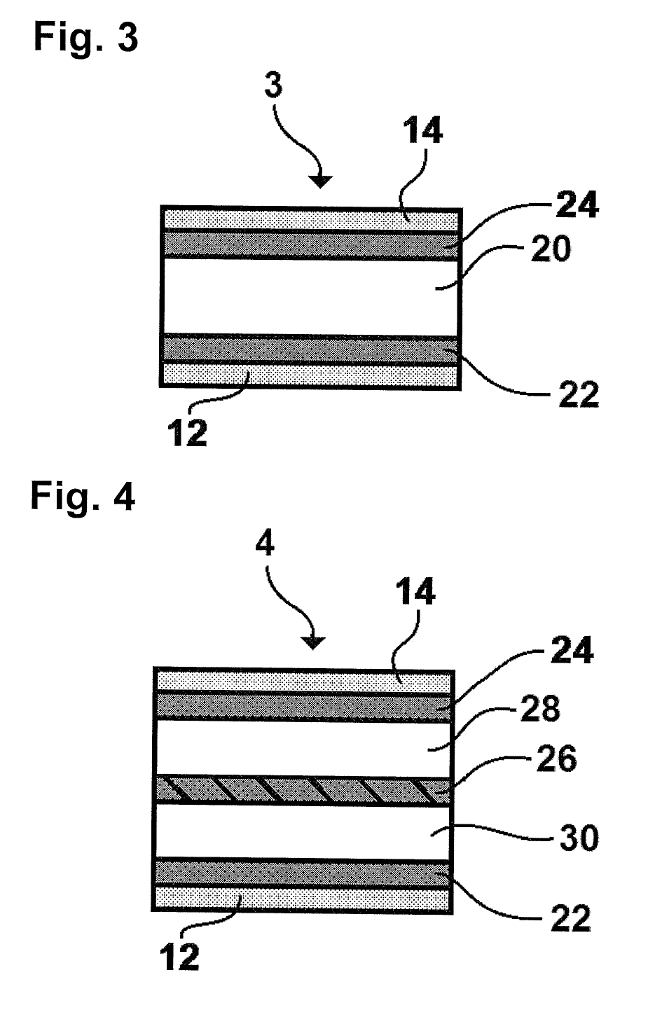

FIG. 3 is a sectional view of a three-layered optical silicone double-side tape 3 according to one embodiment of the present invention. As illustrated in FIG. 3, a multi-layered adhesive layer of a three-layer is formed by forming first and second pressure-sensitive adhesive layers 22, 24 on and under a silicone substrate layer 20. The first and second pressure-sensitive adhesive layers 22, 24 can consist of the same materials to have the same modulus values, or can consist of different materials to have different modulus values. The optical silicone double-side tape of the present invention is provided by forming release liners 12, 14 on both sides of the multi-layered adhesive layer.

FIG. 4 is a sectional view of a multi-layered optical silicone double-side tape 4 according to one embodiment of the present invention. As illustrated in FIG. 4, a silicone substrate layer consisting of three layers is formed by forming a second silicone substrate layer 28 having a G′ modulus value different from a first silicone substrate layer 26 on the first silicone substrate layer 26 and a third silicone substrate layer 30 having a G′ modulus value different from a first silicone substrate layer 26 under the first silicone substrate layer 26. A multi-layered adhesive layer is formed by forming first and second pressure-sensitive adhesive layers 22, 24 on and under the three-layered silicone substrate layer. The first and second pressure-sensitive adhesive layers 22, 24 can consist of the same materials to have the same modulus values, or can consist of different materials to have different modulus values. The optical silicone double-side tape of the present invention is provided by forming release liners 12, 14 on both sides of the multi-layered adhesive layer.

In the multi-layered optical silicone double-side tape 4 of FIG. 4, either one of the first pressure-sensitive adhesive layer 22 or the second pressure-sensitive adhesive layer 24 can be formed. For example, only one of the pressure-sensitive adhesive layers 22, 24 may be present (not shown).

In addition, among the silicone substrate layers consisting of two or more layers, when the layer which has the lowest G′ modulus is a first silicone substrate layer, it is preferable if the silicone substrate layer closer to the first silicone substrate layer has a higher G′ modulus than the first silicone substrate layer. The closeness means it is close to the first silicone substrate layer on the basis of top direction and bottom direction, respectively, and it means that closeness is not compared between a layer on the top-side direction and a layer on the bottom-side direction.

For example, various arrangements are possible according to modulus values as shown in Table 1. In Table 1, silicone substrate layer A, silicone substrate layer B, silicone substrate layer C, silicone substrate layer D, and silicone substrate layer E are sequentially stacked from top to bottom.

TABLE 1

| | The order of modulus values | | | | | | | | |
|---|---|---|---|---|---|---|---|---|---|
| Silicone substrate layer A | 1 | 2-5 | 2-5 | 3-5 | 4-5 | 5 | 2-5 | 1 | 3-5 |
| Silicone substrate layer B | 2-5 | 1 | 1 | 2 | 3 | 4 | 1 | 2 | 2-4 |
| Silicone substrate layer C | — | — | 2-5 | 3-5 | 4-5 | 5 | 2 | 3 | 1 |
| Silicone substrate layer D | — | — | — | — | — | — | 3-5 | 4 | 2-4 |
| Silicone substrate layer E | — | — | — | — | — | — | — | 5 | 3-5 |

*The modulus values are as 5 > 4 > 3 > 2 > 1.

In the present invention, the silicone substrate layer itself also can have tackiness and adhesiveness, so the silicone substrate layer can do as a pressure-sensitive adhesive layer. In addition, the silicone substrate layer is capable of buffering against external impacts and can be used as an impact absorption layer.

Both an addition reaction-type adhesive and a condensation reaction-type adhesive can be used as the silicone substrate layer of the present invention, and all kinds of conventional silicone substrate layers can be used. For example, the constitutional components and their proportions are disclosed in detail in U.S. Pat. No. 5,082,706, U.S. Pat. No. 6,798,467 B2, U.S. Pat. No. 6,703,120 B1, U.S. Pat. No. 7,687,591 B2, U.S. Pat. No. 7,659,003 B2, international publication No. WO 2012/166870 A1, EP Patent No. EP 0537784 B1, etc.

In various embodiments, the silicone substrate layer has a G′ modulus of about 0.1 to about 5 MPa at −40° C., about 0.05 to about 0.5 MPa at −20° C., about 0.02 to about 0.2 MPa at 0° C., and about 0.01 to about 0.1 MPa at 60° C. In the above temperatures, if the modulus exceeds the aforementioned upper limits, a silicone double-side tape having stable modulus in a wide range of temperature cannot be made, and if the modulus is lower than the aforementioned lower limits, adhesive strength is not enough at high temperatures.

In addition, the (average) thickness of the silicone substrate layer is generally from about 0.01 to about 3 mm, alternatively from about 0.02 to about 1 mm, alternatively from about 0.03 to about 0.15 mm. If the thickness of the silicone substrate layer is less than the aforementioned lower limits, the strength of the substrate layer becomes weak, and if it exceeds the aforementioned upper limits, it becomes problematic during the die cutting process.

The pressure-sensitive adhesive layer of the present invention is a film which has adhesive strength, and any pressure-sensitive adhesive which has higher G′ modulus than the silicone substrate layer can be used. The coating thickness is generally 0.01 mm or more, and acryl-type, rubber-type, urethane, and silicone adhesives, etc., can be used.

For example, the pressure-sensitive adhesive layers that can be used in the present invention are disclosed in KR Patent Appl. Laying-open Nos. KR 2013-0063939 A, KR 2014-0014550 A, U.S. Pat. No. 4,288,450, U.S. Pat. No. 8,604,130 B2, KR Patent Nos. KR 1309823 B1, KR 1127105 B1, etc.

In various embodiments, the pressure-sensitive adhesive layer has a G′ modulus of about 5 to about 1000 MPa at −40° C., about 0.5 to about 500 MPa at −20° C., about 0.2 to about 10 MPa at 0° C., and about 0.02 to about 1 MPa at 60° C. In the above temperatures, if the modulus exceeds the aforementioned upper limits, the adhesive strength becomes too low to perform as an adhesive, and if the modulus is lower than the aforementioned lower limits, the adhesive strength is not sufficient at high temperatures.

In addition, the (average) thickness of the pressure-sensitive adhesive layer is generally from about 0.005 to about 0.03 mm, alternatively from about 0.005 to about 0.02 mm, alternatively from about 0.005 to about 0.015 mm. If the thickness of the pressure-sensitive adhesive layer is less than the aforementioned lower limits, the adhesive strength is not high enough and coatability decreases, and if it exceeds the aforementioned upper limits, the influence of the modulus to the entire silicone tape will be too high.

In the present invention, anything that can be released from the silicone substrate layer and the pressure-sensitive adhesive layer can be used as the release liner, and all the conventional release liners can be used. Specifically, a fluoro silicone or silicone release liner can be used as the release liner.

In addition, in one embodiment of the present invention, a double-side tape of a multilayer having different modulus values can be formed, and the total modulus and adhesive strength can be modified in accordance with various uses. Moreover, by designing the adhesive strengths of the two sides of the tape to be different, or by adding color, fragrance, etc., on each layer, a double-side tape having various functions and shapes can be provided.

The silicone double-side tape of the present invention shows more stable modulus in a wide range of temperature than the general acrylic or other organic adhesives.

The modulus of silicone adhesives can be easily controlled by the molecular weight or the contents of the MQ resins. For example, these are specifically disclosed in EP 0 537 784 B1, etc.

The silicone double-side tape of the present invention may exhibit transparency or semi-transparency.

Hereinafter, the optical silicone double-side tape of the present invention and its adhesive properties will be explained in detail with reference to the following examples and comparative examples.

### Example 1

On a fluoro silicone release liner, an adhesive was coated and cured to have a final thickness of 10 microns, and another adhesive was coated and cured to have a final thickness of 10 microns on another fluoro silicone release liner. A silicone substrate layer was then coated and cured between the two adhesive layers to have a final thickness of 80 microns. All were combined to form a layer and, as a result, the total thickness of a transparent silicone double-side tape was 100 microns. As for the curing condition in the lab, curing was proceeded for 2.5 minutes each by using two types of heat sources at 70° C. and 150° C., respectively, to prevent bubble formation. After combining the silicone substrate layer and the two adhesive layers, the product was aged at 50° C. for 3 days to obtain stable properties.

### Examples 2 to 9

The silicone substrate layers used in Examples 2 to 9 were identical to that of Example 1. However, different types of adhesives were used for the adhesive layer compared to Example 1. That is, silicone adhesives having different adhesive strengths were used in Examples 1, 2, 4, and 7, modified acrylic adhesives for Examples 3, 6, and 8, and acrylic adhesives for Examples 5 and 9.

The method for T-peel test was as follows:

After peeling of one release liner, the adhesive tape was combined using a roll of 2 kg to a PET backing film of 50 microns. The release liner on the opposite side was then peeled and a PET backing film of 50 microns was combined to the adhesive-side using a roll of 2 kg. The specimen was cut in a width of 1 inch, and after 30 minutes of residence time, the adhesive strength was measured with a texture analyzer of Lloyd Instruments. Herein, the peeling rate was set at 300 mm/min. The peeling rate was uniformly set at 300 mm/min since the adhesive strength increases as the peeling rate becomes faster.

### Comparative Examples 1 to 8

In Comparative Examples 1 to 8, a silicone adhesive layer was coated and cured on a fluoro silicone release liner to have a final thickness of 100 microns.

The curing condition, T-peel test, etc., were performed identically to Example 1.

The adhesive layer according to the present invention of Examples 1 to 9, and the adhesive layer consisting of a single layer of silicone adhesive of Comparative Examples 1 to 8 were compared in Tables 2 and 3 below. In Tables 2 and 3, the temperature and the value of Tg are based on when the Tan delta is the highest.

TABLE 2

| | | Adhesion | Adhesion | G′ | G′ | G′ | G′ | G′ |
|---|---|---|---|---|---|---|---|---|
| | | strength | strength | (MPa) | (MPa) | (MPa) | (MPa) | (MPa) |
| | | (g/inch) | (g/inch) | at | at | at | at | at |
| Ex. | Constitution | at RT | at 60° C. | −40° C. | −20° C. | 0° C. | 25° C. | 60° C. |
| 1 | PSA layer | — | — | 297.0 | 72.9 | 1.570 | 0.172 | 0.073 |
| | Core layer | 506 | 187 | 0.238 | 0.089 | 0.059 | 0.050 | 0.048 |
| | 3 layers | 1898 | 1002 | 0.659 | 0.286 | 0.162 | 0.101 | 0.064 |
| 2 | PSA layer | — | — | 190.00 | 4.070 | 0.317 | 0.104 | 0.073 |
| | Core layer | 506 | 187 | 0.238 | 0.089 | 0.059 | 0.050 | 0.048 |
| | 3 layers | 1887 | 982 | 0.546 | 0.232 | 0.116 | 0.073 | 0.052 |
| 4 | PSA layer | — | — | 68.60 | 10.80 | 0.915 | 0.132 | 0.044 |
| | Core layer | 506 | 187 | 0.238 | 0.089 | 0.059 | 0.050 | 0.048 |
| | 3 layers | 1582 | 636 | 0.519 | 0.215 | 0.121 | 0.080 | 0.053 |
| 5 | PSA layer | — | — | 12.60 | 4.20 | 1.270 | 0.344 | 0.069 |
| | Core layer | 506 | 187 | 0.238 | 0.089 | 0.059 | 0.050 | 0.048 |
| | 3 layers | 746 | 206 | 0.381 | 0.085 | 0.050 | 0.041 | 0.041 |
| 6 | PSA layer | — | — | 6.550 | 1.830 | 0.434 | 0.117 | 0.045 |
| | Core layer | 506 | 187 | 0.238 | 0.089 | 0.059 | 0.050 | 0.048 |
| | 3 layers | 689 | 199 | 0.271 | 0.071 | 0.043 | 0.036 | 0.034 |
| 7 | PSA layer | — | — | 35.00 | 16.50 | 5.960 | 0.875 | 0.050 |
| | Core layer | 506 | 187 | 0.238 | 0.089 | 0.059 | 0.050 | 0.048 |
| | 3 layers | 988 | 378 | 0.778 | 0.249 | 0.117 | 0.072 | 0.054 |
| 9 | PSA layer | — | — | 8.520 | 3.880 | 1.240 | 0.357 | 0.066 |
| | Core layer | 506 | 187 | 0.238 | 0.089 | 0.059 | 0.050 | 0.048 |
| | 3 layers | 970 | 343 | 0.781 | 0.253 | 0.115 | 0.070 | 0.053 |

PSA layer: pressure-sensitive adhesive layer
Core layer: silicone substrate layer

TABLE 3

| | | Adhesion | Adhesion | G′ | G′ | G′ | G′ | G′ |
|---|---|---|---|---|---|---|---|---|
| | | strength | strength | (MPa) | (MPa) | (MPa) | (MPa) | (MPa) |
| Comp. | | (g/inch) | (g/inch) | at | at | at | at | at |
| Ex. | Constitution | at RT | at 60° C. | −40° C. | −20° C. | 0° C. | 25° C. | 60° C. |
| 1 | Single layer | 770 | 170 | 1.030 | 0.354 | 0.143 | 0.042 | 0.039 |
| 2 | Single layer | 1220 | 450 | 3.280 | 0.773 | 0.211 | 0.070 | 0.055 |
| 3 | Single layer | 1200 | 420 | 3.510 | 0.880 | 0.193 | 0.083 | 0.058 |
| 4 | Single layer | 800 | 220 | 0.608 | 0.206 | 0.102 | 0.052 | 0.051 |
| 5 | Single layer | 1030 | 340 | 1.440 | 0.575 | 0.158 | 0.072 | 0.056 |
| 6 | Single layer | 950 | 250 | 0.712 | 0.191 | 0.079 | 0.016 | 0.012 |
| 7 | Single layer | 1150 | 320 | 5.010 | 1.650 | 0.748 | 0.052 | 0.058 |
| 8 | Single layer | 1760 | 780 | 50.80 | 10.00 | 3.540 | 0.420 | 0.388 |

As shown in Tables 2 and 3 above, the silicone adhesive products of a single layer having low modulus (Comparative Examples 1 to 8) have generally lower adhesive strengths than those of Examples 1 to 9 at room temperature (RT) and high temperature. The single layered adhesive products showed low adhesive strength at high temperatures when the modulus was low, and the single layered adhesive products which have high adhesive strength at high temperatures had too high modulus. Meanwhile, in Examples 1 to 9, which are composed of three layers, a layer which has relatively much higher modulus or high adhesive strength was coated as thin films so that the entire adhesive layer maintained low modulus while high adhesive strength was obtained.

In addition, as shown in Tables 2 and 3, even when organic type adhesives other than the silicone adhesive such as acrylic and modified acrylic adhesives are used as a pressure-sensitive adhesive, if an adhesive of high G′ modulus or high adhesive strength is used, low modulus in total and high adhesive strength can be provided.

The terms “comprising” or “comprise” are used herein in their broadest sense to mean and encompass the notions of “including,” “include,” “consist(ing) essentially of,” and “consist(ing) of. The use of “for example,” “e.g.,” “such as,” and “including” to list illustrative examples does not limit to only the listed examples. Thus, “for example” or “such as” means “for example, but not limited to” or “such as, but not limited to” and encompasses other similar or equivalent examples. The term “about” as used herein serves to reasonably encompass or describe minor variations in numerical values measured by instrumental analysis or as a result of sample handling. Such minor variations may be in the order of ±0-25, ±0-10, ±0-5, or ±0-2.5, % of the numerical values. Further, The term “about” applies to both numerical values when associated with a range of values. Moreover, the term “about” may apply to numerical values even when not explicitly stated.

Generally, as used herein a hyphen “-” or dash “-” in a range of values is “to” or “through”; a “>” is “above” or “greater-than”; a “≥” is “at least” or “greater-than or equal to”; a “<” is “below” or “less-than”; and a “≤” is “at most” or “less-than or equal to.” On an individual basis, each of the aforementioned applications for patent, patents, and/or patent application publications, is expressly incorporated herein by reference in its entirety in one or more non-limiting embodiments.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described herein in an illustrative manner, and it is to be understood that the terminology which has been used is intended to be in the nature of words of description rather than of limitation. Many modifications and variations of the present invention are possible in light of the above teachings. The present invention may be practiced otherwise than as specifically described within the scope of the appended claims. The subject matter of all combinations of independent and dependent claims, both single and multiple dependent, is herein expressly contemplated.

### REFERENCE NUMBERS

1: conventional optical acrylic adhesive tape
2: bi-layered optical silicone double-side tape
3: three-layered optical silicone double-side tape
4: multi-layered optical silicone double-side tape
10: optical acrylic adhesive layer
12: first release liner
14: second release liner
18: pressure-sensitive adhesive layer
20: silicone substrate layer
22: first pressure-sensitive adhesive layer
24: second pressure-sensitive adhesive layer
26: first silicone substrate layer
28: second silicone substrate layer
30: third silicone substrate layer

1. An optical silicone double-side tape comprising:
a multi-layered adhesive layer comprising;
a silicone substrate layer, and
a pressure-sensitive adhesive layer formed on at least one side of the silicone substrate layer; and
release liners formed on both sides of the multi-layered adhesive layer;
wherein the pressure-sensitive adhesive layer has a higher G′ modulus than the silicone substrate layer.

2. The optical silicone double-side tape according to claim 1, wherein the multi-layered adhesive layer is a bi-layered adhesive layer consisting of the silicone substrate layer and the pressure-sensitive adhesive layer having higher G′ modulus than the silicone substrate layer.

3. The optical silicone double-side tape according to claim 1, wherein the silicone substrate layer comprises a silicone substrate layer having the lowest G′ modulus and another silicone substrate layer having higher modulus than the lowest modulus silicone substrate layer, and wherein the pressure-sensitive adhesive layer has the highest G′ modulus.

4. The optical silicone double-side tape according to claim 1, wherein the silicone substrate layer has G′ modulus of 0.1 to 5 MPa at −40° C., 0.05 to 0.5 MPa at −20° C., 0.02 to 0.2 MPa at 0° C., and 0.01 to 0.1 MPa at 60° C.

5. The optical silicone double-side tape according to claim 1, wherein the thickness of the silicone substrate layer is from 0.01 to 3 mm.

6. The optical silicone double-side tape according to claim 1, wherein the pressure-sensitive adhesive layer has G′ modulus of 5 to 1000 MPa at −40° C., 0.5 to 500 MPa at −20° C., 0.2 to 10 MPa at 0° C., and 0.02 to 1 MPa at 60° C.

7. The optical silicone double-side tape according to claim 1, wherein the thickness of the pressure-sensitive adhesive layer is from 0.005 to 0.03 mm.

8. The optical silicone double-side tape according to claim 1, wherein the release liner is a fluoro silicone or silicone release liner.

9. The optical silicone double-side tape according to claim 1, wherein a pressure-sensitive adhesive layer is formed on both sides of the silicone substrate layer.

10. An impact absorption layer comprising the optical silicone double-side tape according to claim 1.

11. The optical silicone double-side tape according to claim 4, wherein the thickness of the silicone substrate layer is from 0.01 to 3 mm.

12. The optical silicone double-side tape according to claim 11, wherein the pressure-sensitive adhesive layer has G′ modulus of 5 to 1000 MPa at −40° C., 0.5 to 500 MPa at −20° C., 0.2 to 10 MPa at 0° C., and 0.02 to 1 MPa at 60° C.

13. The optical silicone double-side tape according to claim 12, wherein the thickness of the pressure-sensitive adhesive layer is from 0.005 to 0.03 mm.

14. The optical silicone double-side tape according to claim 4, wherein the pressure-sensitive adhesive layer has G′ modulus of 5 to 1000 MPa at −40° C., 0.5 to 500 MPa at −20° C., 0.2 to 10 MPa at 0° C., and 0.02 to 1 MPa at 60° C.

15. The optical silicone double-side tape according to claim 6, wherein the thickness of the pressure-sensitive adhesive layer is from 0.005 to 0.03 mm.
